(19) United States
(12) Patent Application Publication
(10) Pub. No.: US 2014/0278460 A1
(43) Pub. Date: Sep. 18, 2014

(54) Mobile Physician Charge Capture Application

(71) Applicants: Stephen Dart, Eltopia, WA (US); Matthew Barron, West Jordan, UT (US); Jared Rich, Midvale, UT (US); Lisa Louvar, Lehi, UT (US); Jared Alviso, Herriman, UT (US)

(72) Inventors: Stephen Dart, Eltopia, WA (US); Matthew Barron, West Jordan, UT (US); Jared Rich, Midvale, UT (US); Lisa Louvar, Lehi, UT (US); Jared Alviso, Herriman, UT (US)

(21) Appl. No.: 13/833,465

(22) Filed: Mar. 15, 2013

(51) Int. Cl. G06Q 30/04; G06Q 50/22

(52) U.S. Cl. CPC G06Q 30/04; G06Q 50/22
USPC 705/2

(57) ABSTRACT

A system and method for allowing a user to create and edit a charge capture slip on an electronic device. The disclosure is suited for use on mobile, touch-sensitive electronic devices. A template screen is presented to a user with medical procedure codes, diagnosis codes, and a summary viewable simultaneously. The user can select codes to add to the summary and can also create customized templates. The user is presented with a multitude of options when viewing a created charge capture slip. The user can delete, modify, and multiply codes. The user can reposition a procedure code on the charge capture slip, while diagnosis codes associated with that procedure code are automatically also repositioned so as to maintain their relationship with the procedure code.

### FIELD OF THE DISCLOSURE

The subject matter of the present disclosure generally relates to electronic billing systems, and more particularly relates to capturing medical charges electronically.

### BACKGROUND OF THE DISCLOSURE

Medical providers are often called upon to provide services when they are away from their offices or away from a traditional desktop computer, and are, therefore, hindered from quickly electronically capturing patient billing charges. Providers often try to capture charges on common sticky notes or small cards. The frequent loss of such hand-written notes can negatively, and significantly, impact the provider's record keeping and billing functions. Also, even if the hand-written notes are kept and presented to the provider's billing assistant, the use of such administrative staff is time consuming, costly, and error-prone. Portable charge capture systems have been previously disclosed, as in United States Patent Application No. 2006/0190297, entitled “Portable Charge Capture and Inventory Management.” The disclosure of Patent Application No. 2006/0190297 is incorporated by reference herein in its entirety. However, such systems require users to transfer between different screens in order to efficiently build a charge slip, and can be cumbersome when a user attempts to prioritize codes on the charge slip.

The subject matter of the present disclosure is directed to overcoming, or at least reducing the effects of, one or more of the problems set forth above.

### BRIEF SUMMARY OF THE DISCLOSURE

Disclosed herein is a system and method that allow a user to create and edit a charge capture slip on an electronic device. A user is presented with a template or charge-selector screen, which connectedly displays procedure codes, diagnosis codes and a charge capture summary view. The simultaneous presentation of all of these elements prevents a user from needing to switch back and forth between screens to collect and view codes and their relationship to each other. When viewing the template screen, the user can select or deselect procedure and diagnosis codes as desired. Selected codes are displayed in the summary view. Optionally, codes can be pre-selected for the user depending on certain criteria, such as the type of appointment involved.

The user can also access a more detailed charge capture slip or edit view, which displays a list of selected codes. The user is presented with the ability to reposition codes within the edit view depending on any relevant prioritization criteria. Diagnosis codes associated with a procedure code can be reorganized. A procedure code can also be relocated within the list. Any diagnosis codes associated with the repositioned procedure code are automatically moved with the procedure code, maintaining the relationship between the procedure code and its associated diagnosis codes. These functions can be accomplished via electronic “drag handles” associated with the codes. Procedure and diagnosis codes can also be deleted or replicated as desired.

An advantage of the disclosure is that charges are easily and immediately captured by the health care provider. The need for the delayed entry of billing charges by administrative staff is eliminated. Furthermore, the record keeping and billing functions of the provider are enhanced.

The details of one or more embodiments of the invention are set forth in the accompanying drawings and descriptions below. The foregoing summary is not intended to summarize each potential embodiment or every aspect of the disclosure.

### BRIEF DESCRIPTION OF THE DRAWINGS

FIGS. 1 through 5 illustrate an embodiment of the present disclosure as displayed on the screen of a touch-sensitive electronic device.

FIG. 1 illustrates a template as presented to the user containing procedure codes, diagnosis codes and a summary view.

FIG. 2 illustrates a customized template tailored to a user's specific needs.

FIG. 3 illustrates the charge capture slip with procedure codes and diagnosis codes and features related to adjusting these codes.

FIG. 4 illustrates an initial charge capture slip and how a user repositions a procedure code as desired.

FIG. 5 illustrates that when a user repositions a procedure code, the diagnosis codes associated with that procedure code are also transferred.

FIG. 6 is a diagram of an exemplary interaction between a user device and a remote digital storage medium.

FIG. 7 is a diagram of an exemplary user device containing a local digital storage medium.

### DETAILED DESCRIPTION OF THE DISCLOSURE

Disclosed herein is a system and method that allow a user to create and edit a charge capture slip on an electronic device. A template, or code-picking screen, for creating a charge slip is presented to the user on the screen of an electronic device. In an exemplary embodiment, the electronic device is Internet-connectible and has a touch-sensitive interface. Exemplary devices may include smart phones, tablet computers, laptops, netbooks, or any similar device. The template connectedly displays available procedure codes, diagnosis codes and a summary of selected codes. The user can select or deselect procedure and diagnosis codes as desired. The summary “window” or view lists procedure codes with their associated diagnosis codes as selected by the user. Procedure and diagnosis codes are stored on a digital storage medium, which may be local to the device, such as on a hard drive or random access memory, or remote to the device, such as a medium accessed through a network or the Internet. For instance, a “cloud-based” digital storage medium can be employed. Optionally, the user can scroll through the summary window using a touch screen or other interface and also change the order of procedure codes and diagnosis codes. In an exemplary embodiment, the user has the ability to “touch and drag” procedure and diagnosis codes into the summary view to collect codes and build a charge capture slip.

In an embodiment procedure codes, diagnosis codes and a summary view are presented simultaneously on a single display screen. Such simultaneous presentation can be advantageous. The user does not need to transfer back and forth between screens to collect and view a summary of the selected procedure and diagnosis codes and their relationship to each other. Optionally, the user has the ability to touch and delete procedure codes. When procedure codes are deleted, associated diagnosis codes are also deleted. Also, in an exemplary embodiment, certain codes can be automatically selected according to a pre-configured setting based on particular criteria, such as appointment type or provider preference.

By touching an edit button or icon the user is taken to a charge capture slip or edit screen view. The edit view displays a listing of the procedure codes currently selected by the user and the diagnosis codes associated with each of these procedure codes. Optionally, the user has the ability to remove individual codes as well as duplicate a given procedure. These functions can be accomplished through the use of buttons or icons. An exemplary delete button is a red hyphenated circle and an exemplary add button is a plus icon. Duplicating a procedure code creates a new set of codes based on the original, including the associated diagnosis codes.

Within the charge capture slip the user can also reposition procedure or diagnosis codes. Multiple diagnosis codes associated with a procedure code can be reordered. Also, a procedure code can be reordered within the charge capture slip list. When a procedure code is repositioned to a new location, all of the diagnosis codes associated with that procedure code follow the procedure code. This maintains a consistent display, simplifies the task of reordering the charge capture slip, prevents workflow disruption and prevents diagnosis codes from being wrongly associated following such a repositioning.

The repositioning or reordering of codes can be optionally accomplished through common “drag and drop” operation and particularly through the use of “move” or “drag” handles associated with individual codes. This functionality can be accomplished in a touch-screen device by the user touching such a handle. In an exemplary embodiment, selecting and holding a row makes that row movable, allowing the user to drag and drop the row into a different vertical order. The “drag and drop” functionality can be utilized to reorganize multiple diagnosis codes associated with a procedure or in repositioning a procedure code and its corresponding diagnosis codes as described above.

FIG. 1 illustrates template 101 as the display of a tablet computer. The template is a charge-selector screen. Template selection button 102 allows the user to select from various templates. Templates can be also be created and customized by the user according to the user's requirements. Template 101 includes list of procedure codes 103 in which there are headers 104 and individual procedure codes 105. Also included is list of diagnosis codes 106 containing individual procedure codes 107. Depending on the number of procedure and diagnosis codes available, lists 103 and 106 will only be a partial list of the available codes. This can accommodate device screen size or allow the most frequently used codes to appear. Patient information box 108 displays information about the patient, such as the patient's name, insurance provider, and appointment dates. The user can select particular procedure code 109 from list of procedure codes 103 by touching the desired procedure code. Likewise, the user can select a particular diagnosis code 110 by touching the desired diagnosis code. A user can deselect a selected procedure code by touching it. The user can search for procedure codes that are not included in the template with search query box 111 and similarly search for diagnosis codes with search query box 112. Charge capture summary 113 displays to the user the procedure codes selected by the user and the diagnosis codes associated with those procedure codes. The user can scroll through summary view 113 using the touch-screen interface and drag and drop procedure and diagnosis codes to add them to the summary. The presentation of list of procedure codes 103 and list of diagnosis codes 106 in conjunction with summary view 113 greatly simplifies the process of creating a charge slip and capturing charges, insuring patients are billed quickly and accurately and freeing the user for other tasks. Edit button 114 allows a user to access a more detailed charge capture slip.

FIG. 2 illustrates customized template 201 as configured by the user. Permitting users to establish customized templates helps facilitate regular activities. For instance, if a physician is performing a routine physical, a customized template may present the physician with procedure codes and diagnosis codes frequently used in such exams, without requiring the user to search the entire list of procedure or diagnosis codes. Optionally, certain procedure and corresponding diagnosis codes are automatically selected and added to summary view 113 when the user loads customized template 201. For instance, if a customized template is set up for a certain type of exam and certain procedure and diagnosis codes are always billed to the patient in such exams, these procedure and diagnosis codes can be automatically selected for the user so that the user is free to concentrate on those procedure and diagnosis codes which are not always used.

FIG. 3 illustrates charge capture slip 301, which is presented to the user when the user touches edit button 114. Selected procedure codes 302 and corresponding diagnosis codes 303 are displayed in a list. The user can delete a particular procedure code 304 by touching a delete icon 305. Deleting particular procedure code 304 also deletes the diagnosis codes associated with that procedure code. A user can also delete a particular diagnosis code 306 by selecting delete button 307. A user can replicate particular procedure code 304 by touching replicate button 308. Selecting this option will also duplicate the diagnosis codes associated with the procedure code. The user can increase the number of units of a procedure by selecting increase icon 309 or decrease the number of units of a procedure by selecting decrease icon 310. Modifier icon 311 allows the user to modify a particular procedure code.

FIG. 4 and FIG. 5 together demonstrate the process of reorganizing charge capture slip 301. In a example, the charge capture slip displays first procedure code 401, with associated first diagnosis code 402 and second diagnosis code 403, and second procedure code 404, with associated third diagnosis code 405 and fourth diagnosis code 406. FIG. 4 shows these codes in an initial state. By touching and holding drag handle icon 407, which is associated with diagnosis code 402, the user can vertically reposition diagnosis code 402 below diagnosis code 403 in charge capture slip 301. By touching and holding procedure drag handle icon 408, which is associated with procedure code 401, the user can vertically reposition procedure code 401 within charge capture slip 301. When the user repositions procedure code 401, diagnosis codes 402 and 403 are also repositioned in such a manner that the relationship between procedure code 401 and diagnosis codes 402 and 403 is maintained. FIG. 5 demonstrates the new configuration resulting from such a repositioning. This functionality allows the user to easily and quickly prioritize procedure and diagnosis codes according to any desired criteria. Maintaining procedure-diagnosis code relationships when procedure codes are moved accelerates the reorganization process while ensuring a consistent and accurate slip.

FIG. 6 is an exemplary diagram of a user device operating in conjunction with a remote digital storage medium. User device 601 has display 602 and processor 603. Server 604 is remote from user device 601 and has digital storage medium 605. Digital storage medium 605 stores, or has encoded on it, procedure codes, diagnosis codes, available templates, and other information, such as patient data. Processor 603 of user device 601 accesses server 604, and thus digital storage medium 605, through a network, such as the Internet. Processor 603 causes procedure codes, diagnosis codes, templates, charge capture slips and other information from digital storage medium 605 to be displayed to the user on display 602. In the embodiment, display 602 is touch-sensitive, and can receive input from the user and pass it to processor 603.

FIG. 7 is an exemplary diagram of a user device in which a digital storage medium is local to the device. User device 701 has display 702, processor 703, and digital storage medium 704. Digital storage medium 704 stores, or has encoded on it, procedure codes, diagnosis codes, available templates, and other information, such as patient data. Processor 703 accesses digital storage medium 704 and causes procedure codes, diagnosis codes, templates, charge capture slips and other information from digital storage medium 704 to be displayed to the user on display 702. In the embodiment, display 702 is touch-sensitive, and can receive input from the user and pass it to processor 703.

One or more embodiments of the present disclosure have been described. Nevertheless, it will be understood that various modifications may be made without departing from the spirit and scope of the invention. Accordingly, other embodiments are within the scope of the following claims.

What is claimed is:

1. A system comprising:
an electronic device having a display;
a digital storage medium;
a set of procedure codes and a set of diagnosis codes encoded on said storage medium;
said electronic device displaying at least a portion of said set of procedure codes, at least a portion of said set of diagnosis codes, and a charge capture summary connectedly when a user views a charge-selector screen on said display of said electronic device.

2. The system of claim 1 wherein said portion of said set of procedure codes, said portion of said set of diagnosis codes, and said charge capture summary are displayed simultaneously.

3. The system of claim 1 wherein said electronic device is also effective to receive input that a particular procedure code of said displayed procedure codes and at least one diagnosis code of said set of diagnosis codes corresponding to said particular procedure code are to be added to said charge capture summary;
said electronic device also effective to add said particular procedure code and said corresponding diagnosis codes to said charge capture summary upon said input.

4. The system of claim 1 wherein said electronic device is a mobile electronic device.

5. The system of claim 1 wherein said set of procedure codes can be searched for a particular procedure code.

6. The system of claim 1 wherein said set of diagnosis codes can be searched for a particular diagnosis code.

7. The system of claim 1 wherein said electronic device has a touch-sensitive interface and said input is effectuated through said touch-sensitive interface.

8. The system of claim 1 wherein at least one particular procedure code and at least one particular diagnosis code are automatically selected and added to said charge capture summary based on a criteria.

9. A system comprising:
an electronic device having a display;
a digital storage medium;
a charge capture slip encoded on said storage medium;
said electronic device displaying the charge capture slip on said display when a user selects to view the charge capture slip;
said charge capture slip having a list of a plurality of procedure codes, each said procedure code having at least one corresponding diagnosis code;
said mobile device effective to receive input that a particular procedure code of said plurality of procedure codes should be relocated within said list;
said mobile device further effective to relocate said particular procedure code and diagnosis codes corresponding to said particular procedure code within said list on said display so as to maintain the relationship between said particular procedure code and its corresponding diagnosis codes;

10. The system of claim 9 wherein said electronic device is a mobile electronic device.

11. The system of claim 9 wherein said electronic device has a touch sensitive interface and said input is a user's touch, holding and dragging of said particular procedure code to a new location in said list.

12. A method comprising:
storing on a digital storage medium a set of procedure codes and a set of diagnosis codes;
displaying on a electronic device a charge-selector screen, containing at least a partial list of said set of procedure codes and at least a partial list of said diagnosis codes, and a summary view.

13. The method of claim 12 wherein said summary view can be scrolled through by a user.

14. The method of claim 12 wherein said partial list of procedure codes and said partial list of diagnosis codes are a pre-configured setting.

15. The method of claim 14 wherein said pre-configured setting can be created by a user.

16. The method of claim 12 wherein at least one particular procedure code and at least one particular diagnosis code are automatically selected based on a criteria.

17. A method comprising:
displaying a charge capture slip on a display of an electronic device, said charge capture slip containing a listing of procedure codes;
receiving input to said electronic device that a particular procedure code in said listing should be relocated within said listing to a desired location;
relocating said particular procedure code, and at least one diagnosis code corresponding to said particular procedure code, within said listing to said desired location in a manner such that the relationship between said particular procedure code and said corresponding diagnosis codes is maintained.

18. The method of claim 16 wherein said electronic device is a mobile electronic device.

19. The method of claim 16 wherein said electronic device has a touch-sensitive interface.

20. The method of 16 wherein said input is an interaction with a touch-sensitive interface.

21. The method of claim 20 wherein said interaction is a user's touching, holding down and dragging of said particular procedure code to the desired location.
